(19) United States
(12) Patent Application Publication
(10) Pub. No.: US 2008/0086699 A1
(43) Pub. Date: Apr. 10, 2008

(54) FAST INPUT COMPONENT

(76) Inventors: MIKA ANTIKAINEN, Tampere (FI); Petri Tuominen, Tampere (FI)

Correspondence Address: PERMAN & GREEN, 425 POST ROAD, FAIRFIELD, CT, 06824, US

(21) Appl. No.: 11/539,653

(22) Filed: Oct. 9, 2006

(51) Int. Cl. G06F 3/048

(52) U.S. Cl. 715/784

(57) ABSTRACT

A graphical user interface is disclosed, that includes selectable items; a set of indices to the selectable items; a presentation field having a subset of the set of indices, wherein the subset is selected from the set of indices by scrolling the presentation field; and an input interface capable of receiving a select indication from a user, wherein the presentation field includes a predetermined position for an index such that upon reception of the select indication, items associated to an index present in the predetermined position are presented by the graphical user interface. An apparatus having such a graphical user interface is also disclosed. Further, a method for selecting items of a graphical user interface, and a computer program for implementing the method are disclosed.

### TECHNICAL FIELD

The disclosed embodiments relate to a graphical user interface, an apparatus utilising such a graphical user interface, a method for selecting items in such a graphical user interface, and a computer program for implementing the method.

### BACKGROUND

Many apparatuses, especially portable apparatuses, form particular demands on the user interface due to its size and the way they are used. As the number of functions and the number of data items that these apparatuses are able to hold has increased enormously, there is a need for improving user accessability of all these functions and data items.

### SUMMARY

In view of the above, the disclosed embodiments solve or at least reduce the problems discussed above. In particular, in one embodiment, selection of items in a graphical user interface is improved.

According to a first aspect of the disclosed embodiments, there is provided a graphical user interface comprising

selectable items;

a set of indices to said selectable items;

a presentation field comprising a subset of said selectable items, wherein said subset is selected by scrolling said selectable items by a direction indicating input interface, wherein, in one direction of said direction indicating input interface, said scrolling is based on said indices, and in another direction, said scrolling is based on items of said presentation field.

That is, the scrolling of the presentation field will act as a sliding window over the set of indices, wherein the scrolling is experienced as sliding the window.

The indices may comprise a first letter of its associated items. The direction indicating input interface may comprise any of the group comprising a joystick, direction buttons, and navigation key.

A set of said indices may be presented in an indices scroll field, wherein said indices scroll field comprises a predetermined position for an index such that upon reception of a select indication, items associated to an index present in said predetermined position are presented in said presentation field.

Only indices associated to a selectable item may be enabled to be part of said set of indices, or all indices may be enabled to be part of said set of indices.

The direction indicating input interface may comprise graphical representations of possible directions on a display of said graphical user interface, wherein said graphical representations are touch sensitive for receiving direction indications, or the direction indicating input interface may comprise a graphical representation of a virtual actuation device on a display of said graphical user interface, wherein said graphical representation is arranged to scroll said indices scroll field by virtually actuating said indices scroll field directly.

An index in said predetermined position may be presented with a larger font than indices adjacent to said predetermined position. The predetermined position may be a center position of said indices scroll field.

According to a second aspect of the disclosed embodiments, there is provided an apparatus comprising a graphical user interface according to the first aspect of the disclosed embodiments. The apparatus may be a mobile phone, a personal digital assistant, a digital camera, a media player, or any other apparatus using a graphical user interface, and where a plurality of items are to be selected.

According to a third aspect of the disclosed embodiments, there is provided a method for selecting items of a graphical user interface, the method comprising enabling selection among indices associated to selectable items by receiving a direction indicator for one direction; presenting items associated with selected indices; and enabling selection among said presented items by receiving a direction indicator for another direction.

The method may further comprise determining a subset of said indices based on said selection of indices; presenting indices belonging to said subset in an indices scroll field; and enabling re-selection of indices by enabling scrolling of indices in said indices scroll field.

The method may further comprise providing a predetermined position in said presentation of indices; enabling selecting of an index present in said predetermined position by receiving a select indication; and presenting items associated with said index present in said predetermined position.

Determining said subset further may comprise determining only indices associated to present selectable items enabled to be part of said subset, or determining all indices enabled to be part of said subset.

Receiving said direction indicators may comprise receiving a signal from a direction indicating input interface comprising any of the group comprising a joystick, direction buttons, and navigation key.

Receiving said direction indicator may comprise presenting graphical representations of possible directions on a touch sensitive display of said graphical user interface, and receiving touch inputs associated with said graphical representations, wherein said inputs comprise said direction indicating input.

Receiving said direction indicating input comprises presenting a graphical representation of a virtual actuation device on a display of said graphical user interface, and scrolling said presentation field by virtually actuating said presentation field directly by said graphical representation.

The method may further comprise presenting an index present in said predetermined position with a larger font than indices adjacent to said predetermined position.

According to a fourth aspect of the disclosed embodiments, there is provided a computer-readable medium having computer-executable components comprising instructions for performing the method according to the third aspect of the disclosed embodiments.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will be better understood through the following illustrative and non-limiting detailed description of preferred embodiments, with reference to the appended drawings, where the same reference numerals will be used for similar elements, wherein:

FIG. 1 shows a mobile communication apparatus with touch sensitive screen according to an embodiment;

FIG. 2 shows a mobile communication apparatus with a joystick for navigation according to an embodiment;

FIG. 3 shows a mobile communication apparatus with navigation means according to an embodiment;

FIG. 4 shows a mobile communication apparatus with rotating input interface for navigation according to an embodiment;

FIG. 5 shows a mobile communication apparatus with a navigation wheel according to an embodiment;

FIG. 6 illustrates a graphical user interface view according to an embodiment, where only indices associated to items that are present are shown in a presentation field;

FIG. 7. illustrates a graphical user interface view according to an embodiment, where a subset of indices from all indices are shown in a presentation field; and

FIG. 8 illustrates a graphical user interface view according to an embodiment.

### DETAILED DESCRIPTION

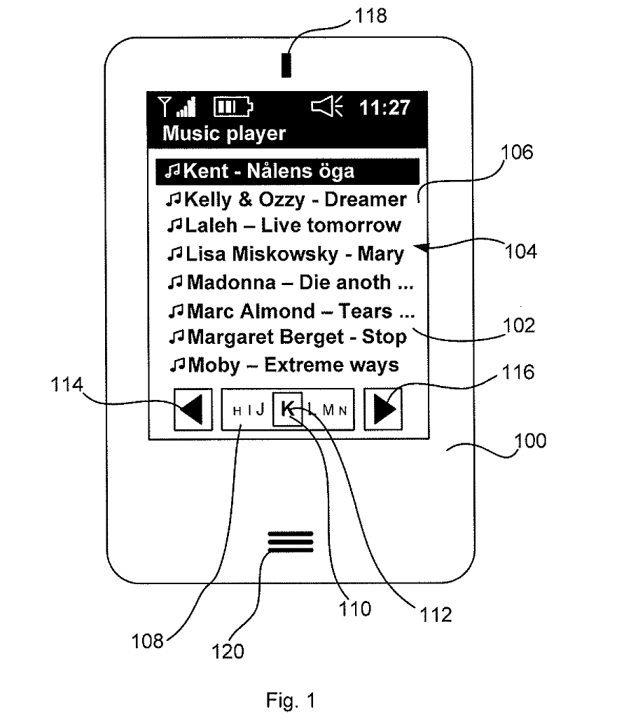

FIG. 1 shows an apparatus 100 comprising a touch sensitive display 102 for navigating among items 104 displayed in a display area 106, wherein the displayed items 104 directly can be tapped by a user for selection.

For enabling improved handling of the apparatus 100 when selecting among item, of which only a part of them can be displayed due to e.g. limitations in display size, the apparatus 100 further comprises a presentation field 108 presenting a subset of indices from a set of indices associated to the entire set of items, i.e. to both displayed and non-displayed items. A particular predetermined position 110 in the presentation field enables a user to select an index 112 being present at this position, whereby the displayed items 104 are determined from this selection. Indices adjacent to this index 112 are preferably presented with a smaller font than this index 112. The font can be smaller as a function of the distance from the predetermined position 110, e.g. the more distant, the smaller font. Only a limited number of indice are presented in the presentation field. Therefore, the presentation field can be scrolled, i.e. the limited number of indices be selected from a larger number of indices. This larger number of indices can either be all indices, e.g. all letters in an alphabet, or only indices having an association to a selectable item, e.g. only letters which is starting letters of names of selectable items.

The presentation field 108 can be accompanied with graphical representations 114, 116 of direction indicators for scrolling. By tapping these representations 114, 116, the presentation field 108 is scrolled accordingly, wherein the index of the predetermined position also is changed. Alternatively, the presentation field can be actuated directly as ‘grab-and-move’, and by determining the speed of this, the presentation field can be virtually spinned, i.e. at determination of a fast grab-and-move input, e.g. over a threshold level, the presentation field is scrolled a predetermined number of indices.

Items associated with the index 112 in the predetermined position 110 are displayed in the screen area 106. This can either be performed upon selection input associated with the presentation field 108, or continuously as the presentation field 108 is scrolled.

The apparatus 100 can be a mobile phone, a personal digital assistant, a digital camera, a media player, etc. The apparatus 100 can also comprise other elements normally present in such an apparatus, such as a keypad (not shown), a speaker 118, a microphone 120, a processor (not shown), a memory (not shown), etc.

In an exemplary use case, the user can use a finger or any other means for pointing at the screen 102 to tap the arrows 114, 116 besides the magnified letter row 108 to select the boxed and enlarged letter 112 in the center 110 of the row. The two arrows 114, 116 besides the magnified letter row area 108 can be used to scroll between the letters. One can also swiftly drag the finger or the pointing means across, to the left or to the right of the magnified letter row area 108, to more quickly scroll between the letters, like spinning a wheel.

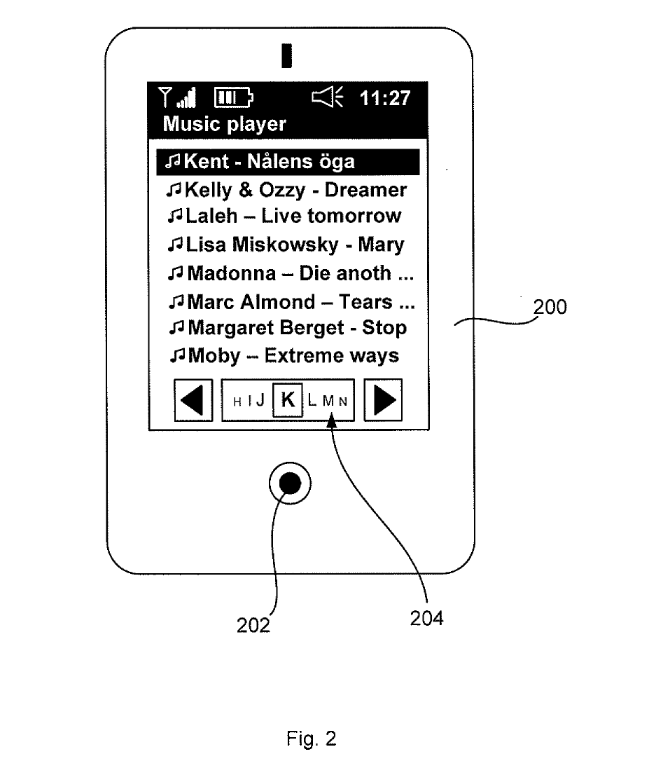

FIG. 2. shows an apparatus 200 according to an embodiment, wherein a joystick 202 is used to navigate and selecting among indices 204 displayed in a presentation field 204. Thus, the joystick 204 is used to indicate direction of scrolling, and can also be used for selecting, e.g. by pushing the joystick 204. The apparatus 200 can also comprise further input and output means. However, these are omitted not to obscure particular features to be illustrated for this embodiment. Further features of the apparatus 200 can be similar to those demonstrated with reference to FIG. 1.

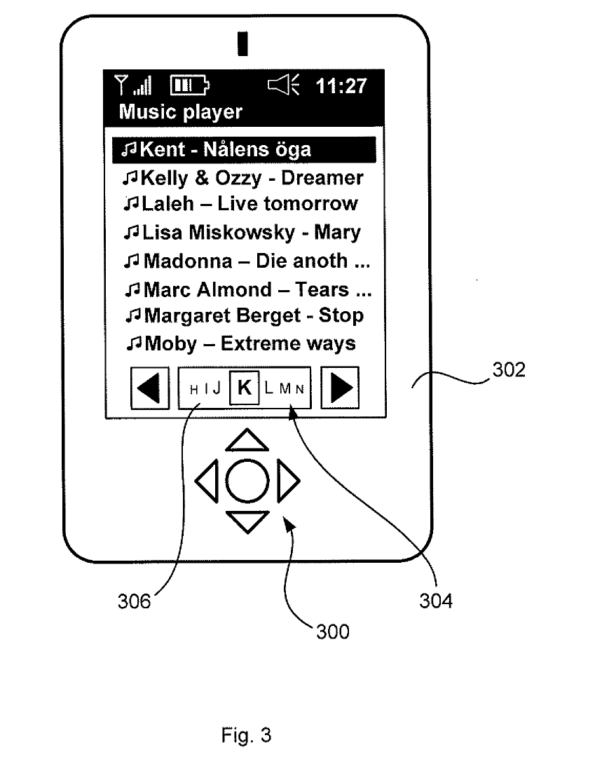

FIG. 3. shows direction input and selection keys 300 of an apparatus 302 according to an embodiment. In the user interface of the apparatus 302, these keys 300 are used to navigate and select among indices 304 displayed in a presentation field 306. The apparatus 302 can also comprise further input and output means. However, these are omitted not to obscure particular features to be illustrated for this embodiment. Further features of the apparatus 302 can be similar to those demonstrated with reference to FIG. 1.

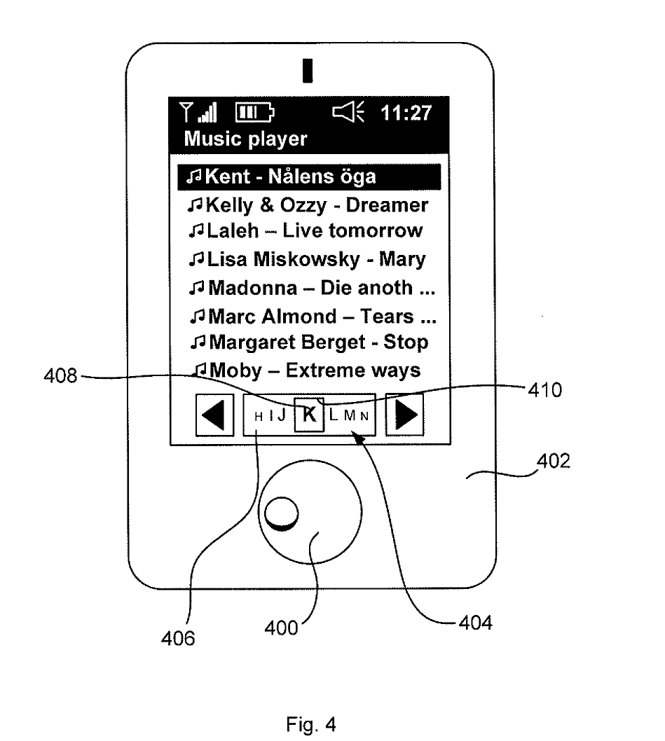

FIG. 4. shows a rotating input interface 400 of an apparatus 402 according to an embodiment. In the user interface of the apparatus 402, the rotating input interface 400 is used to navigate among indices 404 displayed in a presentation field 406. The rotating input interface 400 can also be used for selecting an index 408 being positioned in a predetermined position 410 of the presentation field 406. The apparatus 402 can also comprise further input and output means. However, these are omitted not to obscure particular features to be illustrated for this embodiment. Further features of the apparatus 402 can be similar to those demonstrated with reference to FIG. 1.

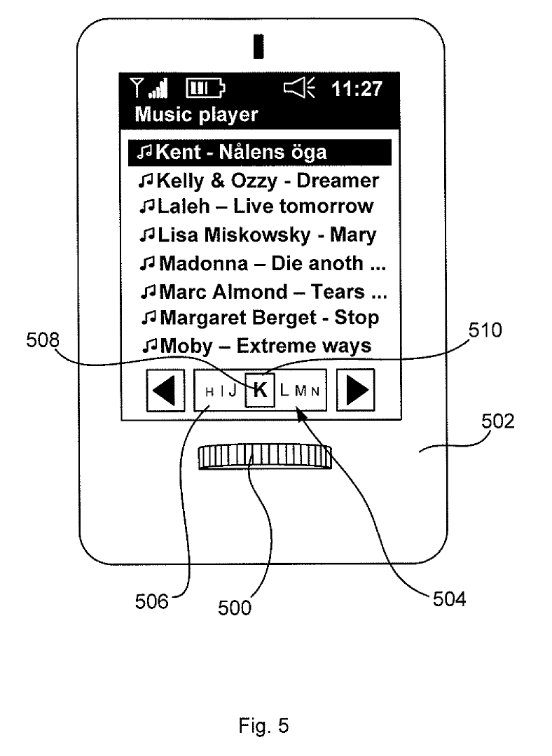

FIG. 5. shows a wheel 500 of an apparatus 502 according to an embodiment. In the user interface of the apparatus 502, the wheel 500 is used to navigate among indices 504 displayed in a presentation field 506. The rotating input interface 500 can also be used for selecting an index 508 being positioned in a predetermined position 510 of the presentation field 406. The apparatus 502 can also comprise further input and output means. However, these are omitted not to obscure particular features to be illustrated for this embodiment. Further features of the apparatus 502 can be similar to those demonstrated with reference to FIG. 1.

Any of the direction input means demonstrated with reference to FIGS. 1 to 5 can be combined, e.g. to let a user decide which one is to be used.

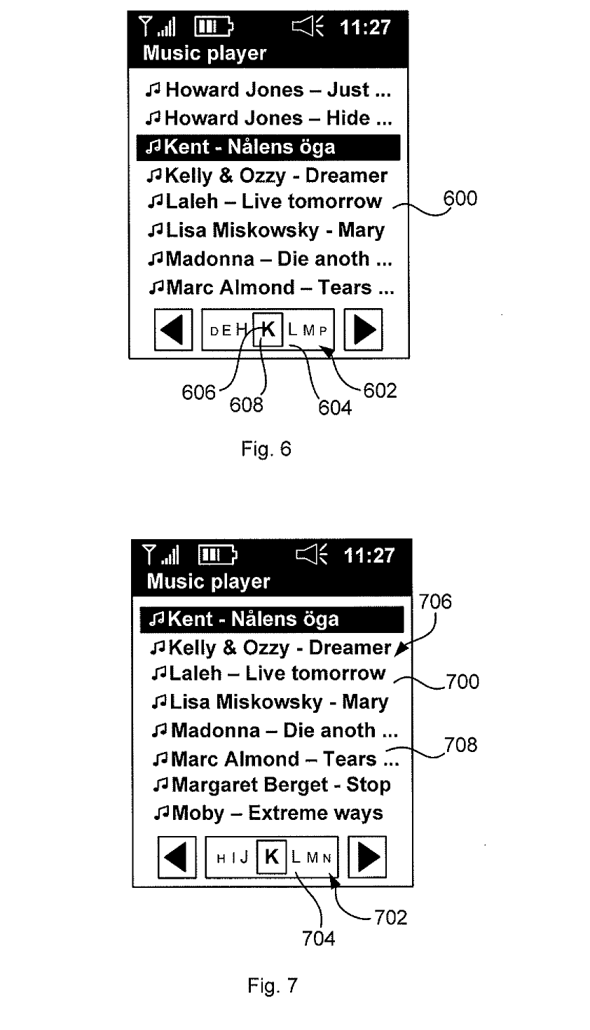

FIG. 6 illustrates a graphical user interface view 600 according to an embodiment, where only indices 602 associated to items that are present are shown in a presentation field 604. This reduces the number of indices to be shown, which provides for a higher rate of indices to be present in the presentation field 604. The first item name corresponding to the index 606, here a letter in a box, in a predetermined position 608 of the presentation field 610, here a magnified letter row area, can be highlighted.

FIG. 7. illustrates a graphical user interface view 700 according to an embodiment, where a subset of indices 702 from all indices, here all letters in the alphabet, are shown in a presentation field 704. When the indices 702 are scrolled in the presentation field 704, items 706 in a display area 708 can also be scrolled directly. Alternatively, the items 706 are scrolled upon reception of a selection.

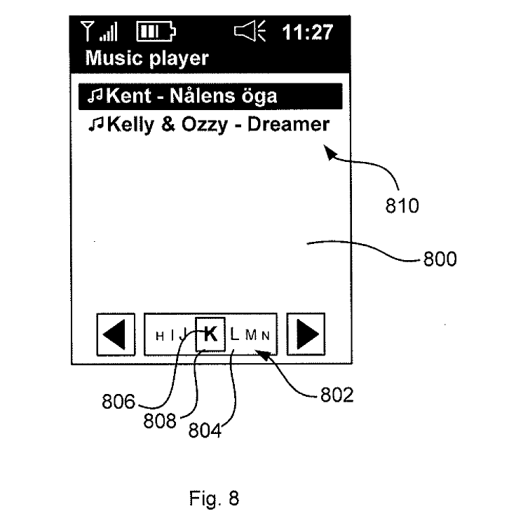

FIG. 8 illustrates a graphical user interface view 800 according to an embodiment, where a subset of indices 802 are shown in a presentation field 804. When the indices 802 has been scrolled to a desired position such that a desired index 806 is present in a predetermined position 808, a selection is made. Upon the selection, only items 810 are shown that are associated to the selected index 806, in the example of FIG. 8, items 810 that have the same first letter as the letter 806 in the magnified letter row area 808.

The invention has mainly been described above with reference to a few embodiments. However, as is readily appreciated by a person skilled in the art, other embodiments than the ones disclosed above are equally possible within the scope of the invention, as defined by the appended patent claims.

1. A graphical user interface comprising
selectable items;
a set of indices to said selectable items;
a presentation field comprising a subset of said selectable items, wherein said subset is selected by scrolling said selectable items by a direction indicating input interface, wherein, in one direction of said direction indicating input interface, said scrolling is based on said indices, and in another direction, said scrolling is based on items of said presentation field.

2. The graphical user interface according to claim 1, wherein said indices comprises a first letter of its associated items.

3. The graphical user interface according to claim 1, wherein said direction indicating input interface comprises any of the group comprising a joystick, direction buttons, and navigation key.

4. The graphical user interface according to claim 1, wherein a set of said indices are presented in an indices scroll field, wherein said indices scroll field comprises a predetermined position for an index such that upon reception of a select indication, items associated to an index present in said predetermined position are presented in said presentation field.

5. The graphical user interface according to claim 4, wherein only indices associated to a selectable item are enabled to be part of said set of indices.

6. The graphical user interface according to claim 4, wherein all indices are enabled to be part of said set of indices.

7. The graphical user interface according to claim 1, wherein said direction indicating input interface comprises graphical representations of possible directions on a display of said graphical user interface, wherein said graphical representations are touch sensitive for receiving direction indications.

8. The graphical user interface according to claim 4, wherein said direction indicating input interface comprises a graphical representation of a virtual actuation device on a display of said graphical user interface, wherein said graphical representation is arranged to scroll said indices scroll field by virtually actuating said indices scroll field directly.

9. The graphical user interface according to claim 4, wherein an index in said predetermined position is presented with a larger font than indices adjacent to said predetermined position.

10. The graphical user interface according to claim 9, wherein said predetermined position is a center position of said indices scroll field.

11. An apparatus comprising a graphical user interface comprising
selectable items;
a set of indices to said selectable items;
a presentation field comprising a subset of said selectable items, wherein said subset is selected by scrolling said selectable items by a direction indicating input interface, wherein, in one direction of said direction indicating input interface, said scrolling is based on said indices, and in another direction, said scrolling is based on items of said presentation field.

12. The apparatus according to claim 11, wherein said indices comprises a first letter of its associated items.

13. The apparatus according to claim 11, wherein said direction indicating input interface comprises any of the group comprising a joystick, direction buttons, and navigation key.

14. The apparatus according to claim 11, wherein a set of said indices are presented in an indices scroll field, wherein said indices scroll field comprises a predetermined position for an index such that upon reception of a select indication, items associated to an index present in said predetermined position are presented in said presentation field.

15. The apparatus according to claim 14, wherein only indices associated to a selectable item are enabled to be part of said set of indices.

16. The apparatus according to claim 14, wherein all indices are enabled to be part of said set of indices.

17. The apparatus according to claim 11, wherein said direction indicating input interface comprises graphical representations of possible directions on a display of said graphical user interface, wherein said graphical representations are touch sensitive for receiving direction indications.

18. The apparatus according to claim 14, wherein said direction indicating input interface comprises a graphical representation of a virtual actuation device on a display of said graphical user interface, wherein said graphical representation is arranged to scroll said indices scroll field by virtually actuating said indices scroll field directly.

19. The apparatus according to claim 14, wherein an index in said predetermined position is presented with a larger font than indices adjacent to said predetermined position.

20. The graphical user interface according to claim 19, wherein said predetermined position is a center position of said indices scroll field.

21. A method for selecting items of a graphical user interface, the method comprising
enabling selection among indices associated to selectable items by receiving a direction indicator for one direction;
presenting items associated with selected indices; and
enabling selection among said presented items by receiving a direction indicator for another direction.

22. The method according to claim 21, further comprising
determining a subset of said indices based on said selection of indices;
presenting indices belonging to said subset in an indices scroll field; and
enabling re-selection of indices by enabling scrolling of indices in said indices scroll field.

23. The method according to claim 22, further comprising
providing a predetermined position in said presentation of indices;
enabling selecting of an index present in said predetermined position by receiving a select indication; and
presenting items associated with said index present in said predetermined position.

24. The method according to claim 21, wherein determining said subset further comprises determining only indices associated to present selectable items enabled to be part of said subset.

25. The method according to claim 21, wherein determining said subset further comprises determining all indices enabled to be part of said subset.

26. The method according to claim 21, wherein receiving said direction indicators comprises receiving a signal from a direction indicating input interface comprising any of the group comprising a joystick, direction buttons, and navigation key.

27. The method according to claim 21, wherein receiving said direction indicator comprises presenting graphical representations of possible directions on a touch sensitive display of said graphical user interface, and receiving touch inputs associated with said graphical representations, wherein said inputs comprise said direction indicating input.

28. The method according to claim 21, wherein receiving said direction indicating input comprises presenting a graphical representation of a virtual actuation device on a display of said graphical user interface, and scrolling said presentation field by virtually actuating said presentation field directly by said graphical representation.

29. The method according to claim 23, further comprising presenting an index present in said predetermined position with a larger font than indices adjacent to said predetermined position.

30. A computer-readable medium having computer-executable components comprising instructions for:
enabling selection among indices associated to selectable items by receiving a direction indicator for one direction;
presenting items associated with selected indices; and
enabling selection among said presented items by receiving a direction indicator for another direction.

31. The computer-readable medium according to claim 30, further comprising instructions for:
determining a subset of said indices based on said selection of indices;
presenting indices belonging to said subset in an indices scroll field; and
enabling re-selection of indices by enabling scrolling of indices in said indices scroll field.

32. The computer-readable medium according to claim 30, further comprising instructions for:
providing a predetermined position in said presentation of indices;
enabling selecting of an index present in said predetermined position by receiving a select indication; and
presenting items associated with said index present in said predetermined position.

33. The computer-readable medium according to claim 30, wherein instructions for determining said subset further comprises instructions for determining only indices associated to present selectable items enabled to be part of said subset.

34. The computer-readable medium according to claim 30, wherein instructions for determining said subset further comprises instructions for determining all indices enabled to be part of said subset.

35. The computer-readable medium according to claim 30, wherein instructions for receiving said direction indicators further comprises instructions for receiving a signal from a direction indicating input interface comprising any of the group comprising a joystick, direction buttons, and navigation key.

36. The computer-readable medium according to claim 30, wherein instructions for determining said subset further comprises instructions for presenting graphical representations of possible directions on a touch sensitive display of said graphical user interface, and receiving touch inputs associated with said graphical representations, wherein said inputs comprise said direction indicating input.

37. The computer-readable medium according to claim 30, wherein instructions for determining said subset further comprises instructions for presenting a graphical representation of a virtual actuation device on a display of said graphical user interface, and scrolling said presentation field by virtually actuating said presentation field directly by said graphical representation.

38. The computer-readable medium according to claim 32, further comprises instructions for presenting an index present in said predetermined position with a larger font than indices adjacent to said predetermined position.
